(19) United States
(12) Patent Application Publication
(10) Pub. No.: US 2004/0027044 A1
(43) Pub. Date: Feb. 12, 2004

(54) Shadow mask for cathode ray tube

(76) Inventors: Hirofumi Hideshima, Tokyo-to (JP); Toshihiro Hatori, Tokyo-to (JP); Akira Makita, Tokyo-to (JP)

Correspondence Address: LADAS & PARRY, 224 SOUTH MICHIGAN AVENUE, SUITE 1200, CHICAGO, IL, 60604, US

(21) Appl. No.: 10/416,133

(22) PCT Filed: Nov. 12, 2001
(86) PCT No.: PCT/JP01/09876

(30) Foreign Application Priority Data
Nov. 10, 2000 (JP) 2000344281
Nov. 10, 2000 (JP) 2000344282
Nov. 17, 2000 (JP) 2000351756

(51) Int. Cl. H01J 29/80

(52) U.S. Cl. 313/402

(57) ABSTRACT

A slot tension-type shadow mask for the cathode-ray tube, slots of which are provided with a pseudo-bridge, and the pseudo-bridge is provided with the deviation in the Y-axis direction, is disclosed. The deviation in the Y-axis direction means the condition that, in the relation between the width of the etching part at the mask outer peripheral edge part side (outside etching part) in the Y-axis direction and the width of the etching part at the mask center part side (inside etching part) in Y-axis direction on the surface facing to a screen (being opposite in direction to an electron gun) , the inside etching part is longer than the outside etching part. The outside etching part means a part between an endmost point a of the protuberance at the mask outer peripheral side in the Y-axis direction and a surface edge point b of the protuberance at the outer peripheral side in the Y-axis direction on the surface facing to the screen. The inside etching part means the part between another endmost point c of the protuberance at the mask center side in the Y-axis direction and another surface edge point d of the protuberance at the mask center side in the Y-axis direction on the surface facing to the screen.

### TECHNICAL FIELD

This invention relates to the tension-type shadow mask for cathode-ray tube.

### RELATED ARTS

Heretofore, as the types of the shadow mask of cathode-ray tube, the press type and the tension type has been known. Recently, because of the necessity for being compliant with the planation of the cathode-ray tube, needs for one-dimensional tension type have grown.

As the one-dimensional tension type shadow mask, the aperture grill type and the slot tension type has been known, wherein the aperture grill type uses a steel plate which has vertical slit holes formed by applying an etching process to the metallic film so as to form the slit holes in a desired shape, and which steel plate is attached to the upper and lower steel frames in a state of applying a relatively high tension; and wherein the slot tension type uses a steel plate which has the same rectangular holes (slots) as those in the press type, and which steel plate is attached to the upper and lower steel frames in a state of applying a relatively weak tension.

However, with respect to the shadow mask of the slot tension type, there was a possibility of mislanding at the X-axis peripheral parts of the shadow mask as a result of the expansion of the steel plate by the heat during the use of the mask. It is because in the X-axis direction to which the tension is not applied the bridges which exist at the upper and the lower sides of each slot are expanded by the heat, and the position in the X-axis direction is varied by a large amount by virtue of the cumulated expansions. Therefore, as the material those which have a low coefficient of thermal expansion has been used. But, an improvement in the aspect of the structure has been desired because the material itself was expensive.

As the means of solving such a problem in the aspect of the structure, a method has been proposed which decreases the number of bridges, i.e., makes each slot so as to be slender in the Y-axis direction of the shadow mask. However, in the case of decreasing the number of the bridges in this way, a problem has been risen that the position of the bridge makes a line on the screen when installing and using the mask in the cathode-ray tube, and the line is taken by the naked eye as a visual obstacle.

To solve such a problem, a technique, the pseudo-bridge, has been proposed. In the technique, as shown in FIG. 4, the pseudo-bridges 4 which each consist of protuberances 2,2 and a lacuna 3 between them are provided at predetermined distances in the Y-axis direction of each slot 1, wherein the protuberances 2,2 protrude toward the center of the slot in the direction of X-axis of slot from either side on the Y-axis direction, and the quantity of passage of the electron beam through the pseudo-bridge 4 is set in a similar level with that of the normal bridge 5, and whereby, the shadows of bridges are formed at distances of 0.5-1.0 mm as is the case with the ordinary slot type cathode-ray tube in order to prevent the visual obstacle. Since the pseudo-bridge 4 has the lacuna 3, it does not expand in the direction of the X-axis at this portion even when receiving any heat, and thus it gives an effect similar to the case of providing slots which are long in the direction of the Y-axis of the shadow mask.

Even in the case of providing such pseudo-bridges, however, some problems, such as the degradation of the color purity by diffused reflection of the electron beam, the incompleteness of the shielding effect to the electron beam near the pseudo-bridge, and the problem of brightness change by the electron beam shift, has been pointed out. Therefore, this technique would be susceptible to improvement.

### SUMMARY OF THE INVENTION

Therefore, a purpose of this invention is to provide an improved shadow mask for the cathode-ray tube.

Also, another purpose of this invention is to provide a shadow mask for the cathode-ray tube which does not give the degradation of the color purity by the diffused reflection of the electron beam even when the pseudo-bridges are formed in the slot tension-type shadow mask.

Moreover, another purpose of this invention is, with respect to the tension slot type shadow mask provided with pseudo-bridges, to provide what has an improved shielding effect to the electron beam at the pseudo-bridges in the periphery edge parts in the Y-axis direction of the mask.

Still another purpose of this invention is, with respect to the tension slot type shadow mask provided with pseudo-bridges, to provide what has an improved shielding effect to the electron beam at the pseudo-bridges in the periphery edge parts in the X-axis direction of the mask.

Moreover, the purpose of this invention is to provide a shadow mask where protuberances of the pseudo-bridges on the panel retain their open-ends rectangularly, and which may decrease the probability of brightness change due to the shift of electron beam.

The first embodiment according to this invention which can achieve the above purposes is a slot tension-type shadow mask for the cathode-ray tube, which is characterized by the fact that slots in the mask are provided individually with a pseudo-bridge which consists of protuberances and a lacuna between them, wherein the protuberances protrude toward the center of the slot in the direction of X-axis of the mask from either side of the slot along the Y-axis direction of the mask; and

in at least a part of the slots, each protuberance of the pseudo-bridge is provided with a deviation in the Y-axis direction, wherein the deviation in the Y-axis direction means a condition that, in the relation between the width of the etching part at the mask outer peripheral edge part side (outside etching part) in the Y-axis direction and the width of the etching part at the mask center part side (inside etching part) in Y-axis direction on the surface facing to a screen (being opposite in direction to an electron gun) , the inside etching part is longer than the outside etching part, the outside etching part being a part between an endmost point of the protuberance at the mask outer peripheral side in the Y-axis direction and a surface edge point of the protuberance at the outer peripheral side in the Y-axis direction on the surface facing to the screen, whereas the inside etching part being a part between another endmost point of the protuberance at the mask center side in the Y-axis direction and another surface edge point of the protuberance at the mask center side in the Y-axis direction on the surface facing to the screen.

According to this invention, since the pseudo-bridges are provided with the deviation in the Y-axis direction, even at the outer peripheral side in the Y-axis direction of the shadow mask, the side being where the incidence angle of the electron beam becomes larger, the diffused reflection will not occur when the electron beam irradiates to the protuberance of the pseudo-bridge. Therefore, the degradation of the color purity which depends on and is caused by the diffused reflection of the electron beam can be prevented.

In this invention, it is preferable that the pseudo-bridges in the slots located at the outer peripheral side in the Y-axis direction of the shadow mask are provided with the deviation in the Y-axis direction.

Further, in this invention, it is preferable that the width of the lacuna of the pseudo-bridge at the outer peripheral side edge on the surface facing to the electron gun becomes wider than that at the mask center side edge, at a rate of 10%-100%.

When the lacuna is formed in the pseudo-bridge provided with the deviation in the Y-axis direction, at the side formed the deviation, i.e., the mask center side, the etching for providing the lacuna is easy to progress, because the thickness of the steel plate decreases under the influence of the deviation. On the other hands, at the outer peripheral side, the formation of lacuna becomes difficult comparatively, because the steel plate is thick owing to a meager influence of the deviation. Therefore, when the etching is performed equally on both sides, there is a possibility that a problem that the lacuna at the outer peripheral side is not formed at the side of may occur. Thus, by designing the width of the lacuna of the pseudo-bridge at the outer peripheral side edge on the surface facing to the electron gun so as to be wider than that at the mask center side edge at a rate of 10%-100%, the above mentioned problem would be precluded.

The second embodiment according to this invention which achieves the above purposes is a slot tension-type shadow mask for the cathode-ray tube, which is characterized by the fact that slots in the mask are provided individually with a pseudo-bridge which consists of protuberances and a lacuna between them, wherein the protuberances protrude toward the center of the slot in the direction of X-axis of the mask from either side of the slot along the Y-axis direction of the mask; and

the inside etching part of the protuberance at the mask center side in the Y-axis direction and facing to the screen has a shape satisfying the relationship:

â<t1×tan á

wherein â is the distance of from the outer peripheral side edge of the inside etching part in the Y-axis direction to the mask center side edge of the protuberance, t1 is the thickness of from the mask center side edge of the protuberance to the surface facing to the screen, and á is the incidence angle of the electron beam to the pseudo-bridge, wherein the incidence angle á is the angle with the Z-axis when the electron beam project its locus on the plane including the Y-axis and Z-axis.

In the second embodiment of this invention, since the protuberance of the pseudo-bridge is made the shape which satisfies the above relationship, the electron beam passing through the protuberance of the pseudo-bridge is obstructed around the outer peripheral edge of the inside etching part in the Y-axis direction. Thus, it is possible to decrease the quantity of electron beam passed through the pseudo-bridge, and a shielding area which is similar with that of the regular bridge can be secured.

The third embodiment according to this invention which achieves the above purposes is a slot tension-type shadow mask for the cathode-ray tube, which is characterized by the fact that slots in the mask are provided individually with a pseudo-bridge which consists of protuberances and a lacuna between them, wherein the protuberances protrude toward the center of the slot in the direction of X-axis of the mask from either side of the slot along the Y-axis direction of the mask; and

the width of the pseudo-bridge in the Y-axis direction is wider than the width of the normal bridge in the Y-axis direction at a rate of 20%-150%.

The quantity of electron beam which passes near the pseudo-bridge can be reduced as a whole by taking the width of the pseudo-bridge in the Y-axis direction widely, even when the lacuna is formed to a larger size in some degree, and thus, the visual obstacle with the shadow of the normal bridge can be sufficiently prevented.

Similarly, in the second embodiment as mentioned above, it is preferable that the width of the pseudo-bridge in the Y-axis direction is wider than the width of the normal bridge in the Y-axis direction at a rate of 20%-150%. It is because the shielding effect to the electron beam near the pseudo-bridge can be more improved by combining the features of both of the second embodiment and third embodiment in this way.

The fourth embodiment according to this invention which achieves the above purposes is a slot tension-type shadow mask for the cathode-ray tube, which is characterized by the fact that slots in the mask are provided individually with a pseudo-bridge which consists of protuberances and a lacuna between them, wherein the protuberances protrude toward the center of the slot in the direction of X-axis of the mask from either side of the slot along the Y-axis direction of the mask; and

the pseudo-bridge formed in each slot has a distance a satisfying the relationship:

ä<t2×tan ã

wherein ä is the distance in the X-axis direction between the outer peripheral side edge of the etching part on the surface facing to the screen in the X-axis direction of the mask and the peripheral side edge of the lacuna of the pseudo-bridge in the X-axis direction, t2 is the thickness between the outer peripheral side edge of the lacuna of the protuberance and the mask surface facing to the screen, and a is the incidence angle of the electron beam to the pseudo-bridge, wherein the incidence angle a is the angle with the Z-axis when the electron beam project its locus on the plane including the X-axis and Z-axis.

In the fourth embodiment of this invention, since the pseudo-bridge is made the shape which satisfies the above relationship, the electron beam passing through the lacuna of the pseudo-bridge is obstructed at the edge of the side opposite to the mask center in the etching part on the mask surface. Thus, it is possible to decrease the quantity of electron beam passed through the lacuna of the pseudo-bridge, and a shadow which has a similar level with that of the regular bridge can be can be reflected onto the panel. The problem that the position of the regular bridge is taken by the naked eye as the line on the screen as a visual obstacle can be prevented by this fact.

Moreover, in the fourth embodiment of this invention, it is preferable that the a which satisfies the above relationship is formed in pseudo-bridges located at positions where the a is not less than 10°. In the region where the ã is less than 10°, i.e., the region near the center in the X-axis direction, the a should be set to a particularly small value when satisfying the above relationship, and thus there is a possibility that the problem of difficulties in the processing may arise.

The fifth embodiment according to this invention which achieves the above purposes is a slot tension-type shadow mask for the cathode-ray tube, which is characterized by the fact that slots in the mask are provided individually with a pseudo-bridge which consists of protuberances and a lacuna between them, wherein the protuberances protrude toward the center of the slot in the direction of X-axis of the mask from either side of the slot along the Y-axis direction of the mask; and

the lacuna has a shape where the width of the lacuna at the middle part of the lacuna is wider than that at end part of the lacuna.

In the fifth embodiment of this invention, since the shape of the lacuna is prepared so that the width of the lacuna at the middle part of the lacuna is wider than that at end part of the lacuna, the shadow of the protuberance of the pseudo-bridge can be an almost rectangular appearance on the panel, and thus, the possibility of the brightness change on the somewhat shifting of electron beam can be expelled considerably.

In the fifth embodiment of this invention, it is preferable that the width of the lacuna at the end part is a 50%-90% width at the middle part. It is because the shadow of protuberance in the pseudo-bridge formed on the panel can form a rectangular appearance when taking the width of the middle part of the lacuna widely, and taking the width of the end part of the lacuna narrowly within this range.

Moreover, in the fifth embodiment of this invention, when forming the above lacuna, it is desirable to use a photomask of diamond or elliptical shape. Because, by using such photomask, the lacuna in the pseudo-bridge which gives the shadow of the protuberance on the panel a rectangular appearance can be prepared.

Also in the first embodiment of this invention, it is preferable that the lacuna has a shape where the width of the lacuna at the middle part of the lacuna is wider than that at end part of the lacuna.

It is because the degradation of the color purity which is caused by the diffused reflection of the electron beam can be more efficiently prevented by combining the features of both of the first embodiment and fifth embodiment in this way.

### BRIEF DESCRIPTION OF THE DRAWINGS

FIG. 1 illustrate an example of the pseudo-bridge in the shadow mask of this invention for the cathode-ray tube, wherein (a) is a plan view and (b) the B-B′ arrow sectional view.

FIG. 2 are schematic plan views which each show the electron gun facing surface of the lacuna of the pseudo-bridge in the shadow mask of this invention for the cathode-ray tube.

FIG. 3 illustrate an example of the pseudo-bridge in the shadow mask for the cathode-ray tube, wherein (a) is a plan view and (b) the A-A′ arrow sectional view.

FIG. 4 is a plan view to illustrate the pseudo-bridge.

FIG. 5 is a schematic plan view to illustrate the slot tension-type shadow mask.

FIG. 6 is a schematic perspective view which shows the assembled condition of the slot tension-type shadow mask.

FIG. 7 are schematic views to illustrate the deviation in the Y-axis direction which was formed in Example 1, wherein (a) is a plan view and (b) a sectional view.

FIG. 8 is a schematic view to illustrate Example 2.

FIG. 9 show an example of the pseudo-bridge in the shadow mask of this invention for the cathode-ray tube, wherein (a) is a plan view and (b) the B-B′ arrow sectional view.

FIG. 10 is a schematic sectional view which shows another example of protuberances of the pseudo-bridge in the shadow mask of this invention for the cathode-ray tube.

FIG. 11 is a schematic plain view which shows yet another example of the pseudo-bridge in the shadow mask of this invention for the cathode-ray tube.

FIG. 12 show an example of the pseudo-bridge in the shadow mask of this invention for the cathode-ray tube, wherein (a) is a plan view and (b) the B-B′ arrow sectional view.

FIG. 13 is a schematic sectional view to illustrate the relationship showing the shape of the pseudo-bridge required in this invention.

FIG. 14 show an example of the pseudo-bridge in the shadow mask for the cathode-ray tube, wherein (a) is a plan view and (b) the A-A′ arrow sectional view.

FIG. 15 show an example of the pseudo-bridge in the shadow mask of this invention for the cathode-ray tube, wherein (a) is a plan view and (b) a plan view which shows a shadow of the pseudo-bridge on the panel in the condition that an electron beam is irradiated.

FIG. 16 show a pseudo-bridge in the conventional shadow mask for the cathode-ray tube, wherein (a) is a plan view and (b) the plan view which shows a shadow of the pseudo-bridge on the panel.

FIG. 17 show the conditions that the electron beam is irradiated to the shadow of the pseudo-bridge on the panel as shown in FIG. 16(b), wherein (a) is a plan view which show the condition that the electron beam is irradiated to the normal site, and (b) a plan view which show the condition that the electron beam is irradiated with a shift.

### BEST MODE FOR CARRYING OUT THE INVENTION

Hereinafter, the shadow mask of this invention for the cathode-ray tube is described in detail based on the embodiments.

This invention is applied to the slot tension-type shadow mask for the cathode-ray tube.

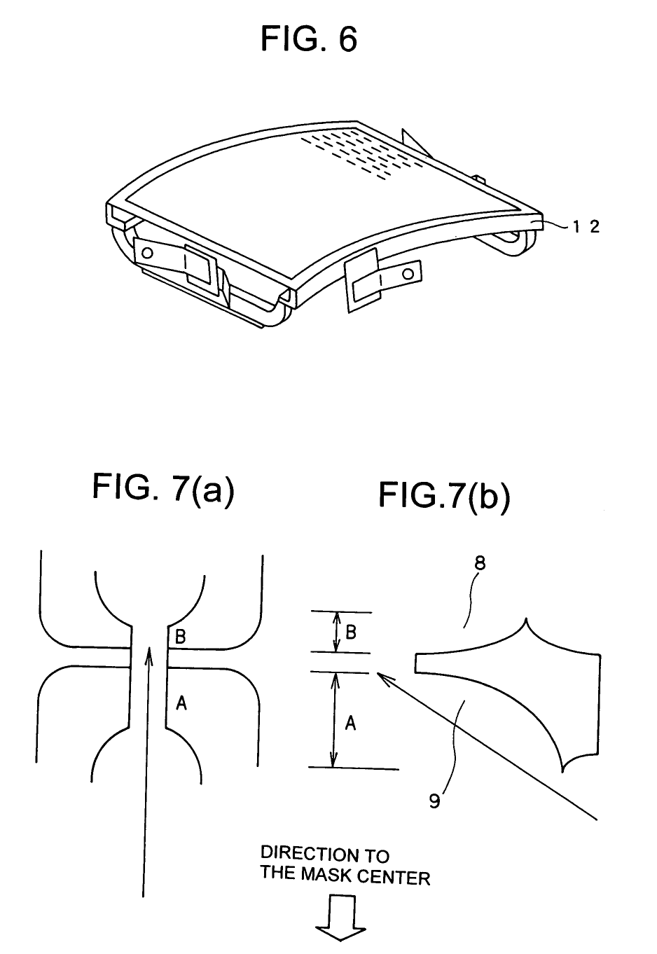

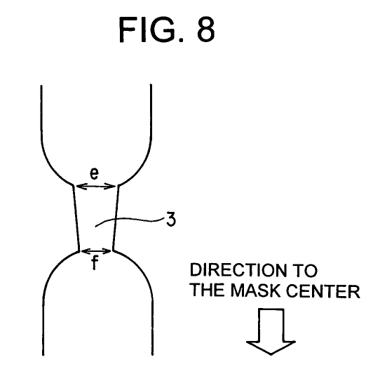

Here, as shown in FIG. 5, the slot tension-type shadow mask for the cathode-ray tube may comprise a cathode rays passage part 10 which comprises a lot of minute rectangular holes (the slot) , and a skirt part 11. The shadow mask of such a slot tension type for the cathode-ray tube is welded in the tense condition to the rectangular frame 12 of steel and so on, as shown in FIG. 6, and then detached from its unnecessary part in order to fix it on the predetermined position inside the panel face of the cathode-ray tube. The cathode rays which are discharged from the electron gun of this cathode-ray tube pass through the cathode rays passage part, then the passed cathode rays make the fluorophor in the whole surface panel fluoresce so that an image is displayed on the panel as the aggregate of the minute luminous dots.

Formation of the Deviation in the Y-Axis Direction

The first embodiment of this invention is characterized by the fact that the pseudo-bridges which are formed at such slots in the shadow mask as mentioned above are provided with the deviation in the Y-axis direction.

As mentioned above, the pseudo-bridge consists of protuberances and a lacuna between them, wherein the protuberances protrude toward the center of the slot in the direction of X-axis of the mask from either side of the slot along the Y-axis direction of the mask, and the pseudo-bridges are formed in the individual slots at regular intervals.

Further, to form a deviation in the Y-axis direction to the pseudo-bridge means to form a deviation in the Y-axis direction to each protuberance of the pseudo-bridge.

Incidentally, the Y-axis direction of the shadow mask, used herein, corresponds to the longitudinal direction of the slots and the direction to which the tension is applied. The X-axis direction used herein is on the face of the shadow mask and is the direction rectangular to the above mentioned Y-axis, and the Z-axis direction is the direction vertical to the shadow mask face.

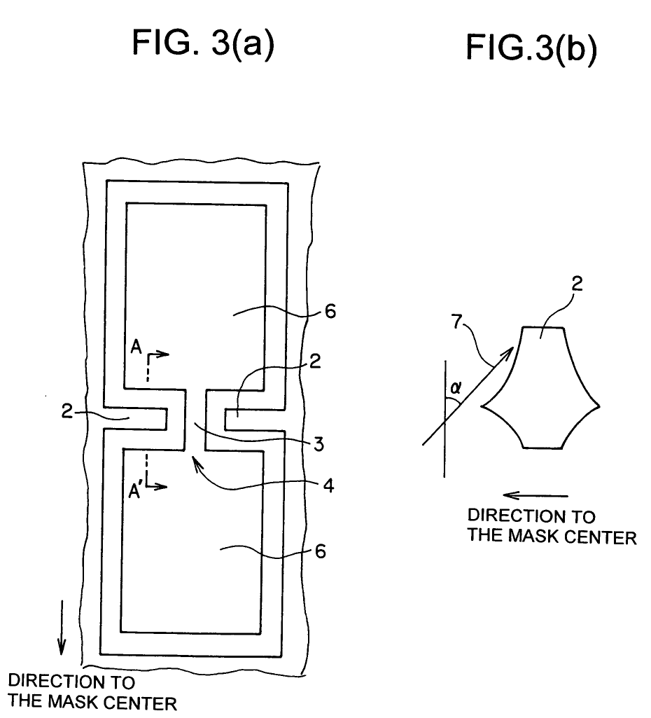

In the prior arts, when such pseudo-bridges were formed in the slots, particularly when the pseudo-bridges were formed at the outer peripheral side in the Y-axis direction of the shadow mask, the diffused reflection occurred in protuberance 2 of the pseudo-bridge and there was possibility that the problems such as giving a bad influence to the image on the cathode-ray tube would occur. This respect will be explained by using FIG. 3.

FIG. 3(a) shows the slot which has two openings 6A, 6B, and the pseudo-bridge 4 which are formed between the openings and which consists of two protuberances 2, 2 and a lacuna 3 existing between the protuberances, and it is a plan view which is seen from the side opposite to the electron gun side, i.e., from the screen side. Further, (b) shows the A-A′ arrow sectional view of (a) . When this slot is situated on a relatively outer peripheral side in the Y-axis direction of the shadow mask, the incidence angle a of the electron beam 7 becomes a relatively large value. When the incidence angle a shows such a relatively large value, the electron beam 7 entered from an area in the opening 6A, wherein the area is located near the protuberance 2 and the opening 6A is the opening of the mask center side in the Y-axis, is shielded by the protuberance 2 of pseudo-bridge 4 as shown in FIG. 3(b). At when shielding, the shielded electron beam 7 is reflected diffusely and there is a problem to have a bad influence on the cathode-ray tube as the result.

On the other hand, in the shadow mask according to this invention, the occurrence of such a problem is eliminated by providing the deviation in the Y-axis direction to the pseudo-bridge as mentioned above.

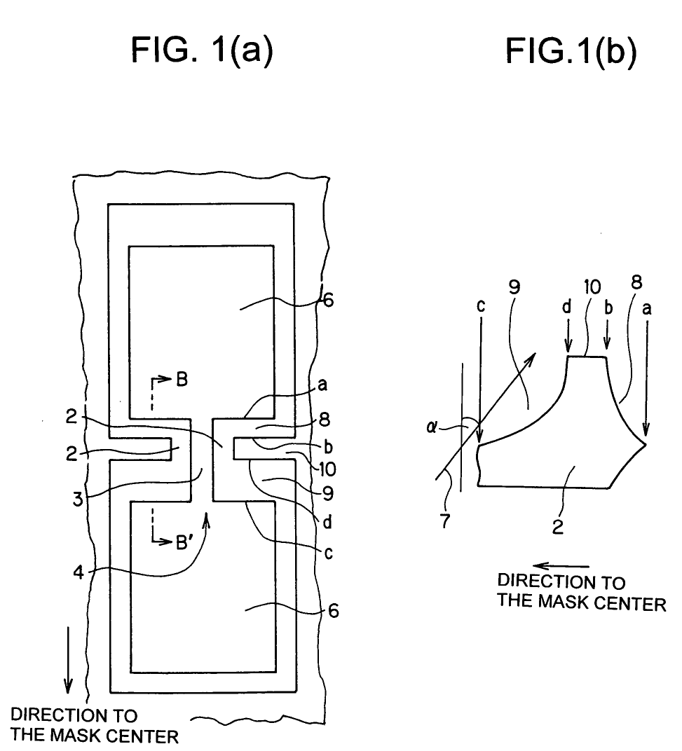

Now, the shadow mask of this invention is described by using the drawings. FIG. 1(a) is a plan view which shows the slot part of the shadow mask according to this invention when viewing from the screen side, and (b) is the B-B′ arrow section view thereof. As the example in these figures, the example that the pseudo-bridge 4 which consists of two protuberances 2, 2 and a lacuna 3 which is formed between them is formed between two openings 6 is illustrated. As described above, this invention is characterized by the fact that the deviation in the Y-axis direction is formed at the protuberances 2 of the pseudo-bridge 4.

With respect to this invention, to form the deviation in the Y-axis direction at the protuberances 2 of the pseudo-bridge 4 means to form the pseudo-bridge so as to satisfy the condition that, in the relation between the width of the etching part 8 at the mask outer peripheral edge part side (outside etching part) in the Y-axis direction and the width of the etching part 9 at the mask center part side (inside etching part) in Y-axis direction on the surface facing .to a screen (being opposite in direction to an electron gun) , the inside etching part 9 is longer than the outside etching part 8, wherein the outside etching part 8 is a part between an endmost point a of the protuberance 2 at the mask outer peripheral side in the Y-axis direction and a surface edge point b of the protuberance 2 at the outer peripheral side in the Y-axis direction on the surface 10 facing to the screen, and wherein the inside etching part 9 is a part between another endmost point c of the protuberance 2 at the mask center side in the Y-axis direction and another surface edge point d of the protuberance 2 at the mask center side in the Y-axis direction on the surface 10 facing to the screen.

As mentioned above, since the deviation in the Y-axis direction is formed to the protuberance 2 in the pseudo-bridge 4, even at the outer peripheral side in the Y-axis direction of the shadow mask, the side being where the incidence angle a of the electron beam 7 becomes larger, the electron beam can pass through the mask without being subjected to shielding, and thus the diffused reflection will not occur. Therefore, The problem for the degradation of the color purity can not come up.

In this invention, in general, the nearer the pseudo-bridge locates to the outer peripheral edge of the shadow mask in the Y-axis direction, the more difference is given between the width of the outside etching part and the width of the inside etching part, and at about the central part of the shadow mask in the Y-axis direction, the deviation in the Y-axis direction are not formed to the pseudo-bridge.

When forming the deviation in the Y-axis direction to the protuberance in the pseudo-bridge, there is a large difference between the thickness of the protuberance 2 at the outside etching part 8 and that at the inside etching part 9 as shown in FIG. 1(b) , and the inside etching part 9 is quite thinner than the outside etching part 8. Thus, when forming the lacuna 3 to such shaped part by etching, the inside etching part 9 is easy penetrated so as to form the lacuna 3, while the outside etching part 8 shows a difficulty for the penetration. When it can not be it is difficult for outside etching part 8 to pierce and it can not be penetrated at the part, there is possibility that the effect as the pseudo-bridge can not be expected.

In this invention, in order to evade such a problem, it is preferable that the width of the lacuna of the pseudo-bridge which has the deviation in the Y-axis direction is formed so as to be large at the outer peripheral side edge on the surface facing to the electron gun, as compared with that at the mask center side edge. The etching quantity at the outside etching part 8 can be increased by such a shape, and the problems that the outside etching part 8 is not penetrated when forming the lacuna 3 can be eliminated.

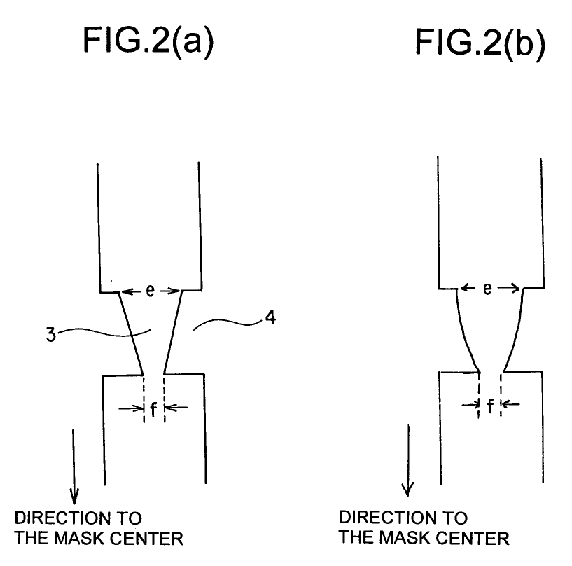

FIG. 2 shows the mask surface on the side of the electron gun at the pseudo-bridge 4 part, and wherein the width e at the outer peripheral edge in the Y-axis direction of the mask is larger than the width f at the mask center side edge.

In this invention, with respect to the width of the lacuna of the pseudo-bridge on the surface of the electron gun side, it is desirable that the width at the outer peripheral side edge is wider than that at the mask center side edge, at a rate of 10%-100%, particularly at a rate of 20-30%, and especially at a rate of 20-25%.

With respect to the shape of the lacuna 3 under such a condition, it may be formed so that its width is enlarged rectilinearly from the mask center side to the outer peripheral side as shown in FIG. 2(a), alternatively, it may be curvilinearly as shown in FIG. 2(b), or it may be any other shape. As far as the width e of lacuna 3 at the outer peripheral edge in the Y-axis direction is larger than the width f at the mask center edge at the above mentioned rate, the outline of lacuna 3 at the part of between the edges is not particularly limited.

The Shield of the Incident Beam at the Pseudo-Bridge (Y-Axis)

To improve the shielding effect of the electron beam near the pseudo-bridge which is provided for the slot of the shadow mask, this invention also provides two means. Now, these are described as second embodiment and third embodiment.

In order to obtain an effect similar to that of the normal slot for the pseudo-bridge formed in the slot, it is desirable that the quantity of the electron beam passed through the lacuna of the pseudo-bridge is suppressed as much as possible. As the way for suppressing the quantity of the electron beam which passes through this lacuna part, to make the width of the lacuna at the pseudo-bridge narrow would be considered, but this technique would have a certain limit because there is a limit in the aspect of the etching precision in this technique. Therefore, the means to suppress the quantity of the electron beam which passes through the lacuna part has been desired.

The second embodiment of this invention has been contrived under such aspect, and its characteristic is laid on a specified shape of the pseudo-bridge formed in the slots of shadow mask.

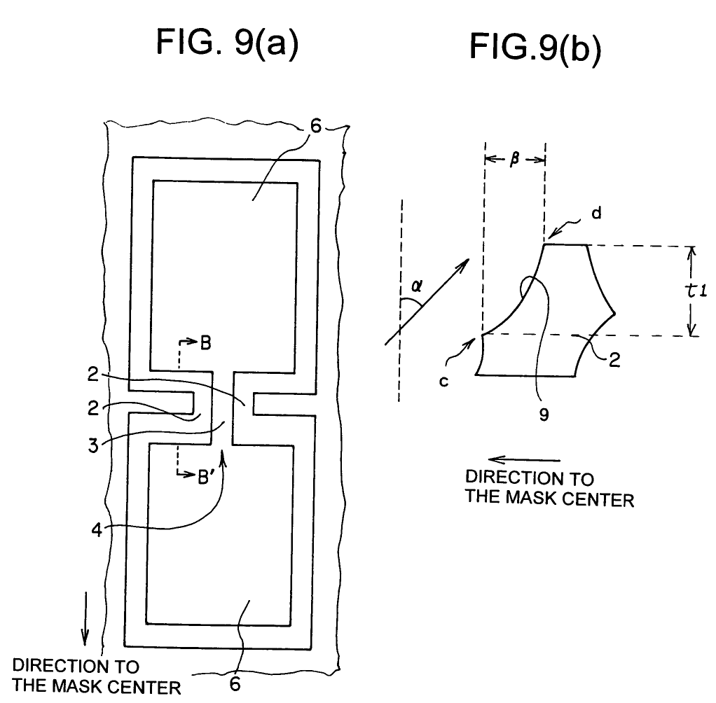

Now, the shape of the pseudo-bridge according to this invention is described using the drawings. FIG. 9(a) is the plan view which shows the slot part of the shadow mask of this invention when viewing from the screen side, and (b) is the B-B′ arrow sectional view thereof. As the example in these figures, the example that the pseudo-bridge 4 which consists of two protuberances 2, 2 and a lacuna 3 which is formed between them is formed between two openings 6, 6 is illustrated. The characteristic of this invention is to make the shape of each protuberance 2 of this pseudo-bridge 4 a shape satisfying the following relationship:

â<t1×tan á

In this expression, â is the distance of from the outer peripheral side edge d of the inside etching part 9 in the Y-axis direction to the mask center side edge c of the protuberance 2 as shown in FIG. 9(b). Incidentally, the inside etching part 9 is the etching part in the above protuberance 2 and which is at the mask center side in the Y-axis direction and at the screen side.

Next, t1 is the thickness of from the above mentioned edge c to the screen side surface of the steel plate, namely, the distance in the direction of Z-axis. Further, á is the incidence angle of the electron beam to the pseudo-bridge 4, wherein the incidence angle á is the angle with the Z-axis when the electron beam project its locus on the plane including the Y-axis and Z-axis.

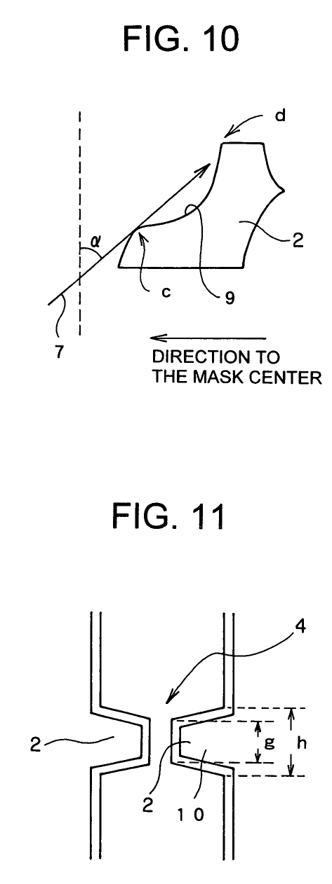

As shown in FIG. 10, when the mask center side edge part c of the protuberance 2 is inaccurate, the position of the edge part c should be determined as follows. Namely, when the incidence angle of the electron beam 7 to the pseudo-bridge 4 that has such protuberance 2 is taken as a, as shown in FIG. 10, the contact point of the straight line which have the angle a with the longitudinal axis on this figure and the mask center side part of the inside etching part 9 is defined as the mask center side edge part c of the protuberance 2.

When the protuberance 2 of the pseudo-bridge is formed so as to satisfy the above relationship, for example, as shown in FIG. 2, at least the electron beam 8 irradiated along the edge c comes to be shielded by the inside etching part 9 located at the mask center side than the edge d of the etching part of the mask surface. Therefore, the quantity of the electron beam which passes near protuberance 2 of pseudo-bridge 4 can be decreased by the quantity of the electron beam which was sheltered as mentioned above. Thereby, the shielding effect of the electron beam at the pseudo-bridge is improved, and the visual obstacle where the normal bridges are emphasized and the horizontal black strips are observed can be prevented more effectively by the pseudo-bridge.

The above-mentioned relationship of this invention can be applied in any area except at the part on the center line of the Y-axis of the shadow mask where á is 0°.

With respect to the thickness of the steel sheet which is used for the shadow mask of this invention for the cathode-ray tube, a thickness within the range of generally used in this art may be adaptable. Concretely, a thickness in the range of 80 μm to 150 μm may be used. The above mentioned t1 generally has a thickness which is a half of or more than half of the thickness of the steel sheet.

Next, a means of the third embodiment according to this invention is described. The means of the third embodiment according to this invention is characterized by the fact that the width of the pseudo-bridge in the Y-axis direction is wider than the width of the normal bridge in the Y-axis direction at a rate of 20%-150%

In order to prevent the horizontal black stripes due to enhancement of the normal bridges, it is desirable that the pseudo-bridge which is used for this invention has a quantity of electron beam shielding similar to that of the normal bridge. However, since the pseudo-bridge has a lacuna at the center part in the X-axis direction thereof, the quantity of the electron beam which passes through the pseudo-bridge is larger than that of the normal bridge by the quantity of passing through the lacuna.

In addition to the above mentioned means according to the second embodiment, as a method for regulating the passage amount of the electron beam, the means of the third embodiment where the width of the pseudo-bridge in the Y-axis direction is wider than the width of the normal bridge in the Y-axis direction can be adaptable.

In this invention, the width of the pseudo-bridge in the Y-axis direction is wider than the width of the normal bridge in the Y-axis direction at a rate of 20%-150%, more preferably at a rate of 40%-60%, when the width of the normal bridge in the Y-axis direction is taken as 100%.

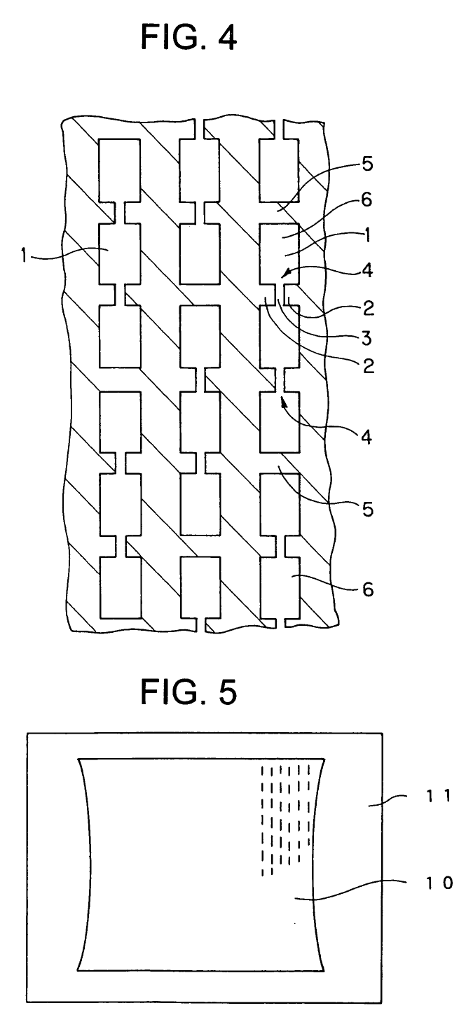

As shown in FIG. 11, the width of the pseudo-bridge in the Y-axis direction according to this invention is determined by measuring the width h of the widest part between the two protuberance 2, 2 of pseudo-bridge 4 in the Y-axis direction and the width g of the narrowest part between the two protuberances 2, 2 of pseudo-bridge 4 in the Y-axis direction, and calculating the mean value of the widths h and g. Incidentally, these widths are what are obtained by measuring the distance between the both edges of the protuberances 2 in the Y-axis direction, but are not what are obtained by measuring the widths at the part of the mask surface 10 where the etching is not performed. The width of the normal bridge is also determined by the a similar way where the width of the widest part of the normal bridge in the Y-axis direction and the width of the narrowest part of the normal bridge in the Y-axis direction are measured in order to calculate the mean value of the measured widths as the width of the normal bridge. Incidentally, the normal bridge 5 is the real part which zones slots 1 (holes) mutually in the Y-axis direction, as shown in the FIG. 4.

In this invention, it is possible to use the means according to the second embodiment in combination with the means according to the second embodiment. In such a case, it is possible to preclude the horizontal black stripes due to enhancement of the normal bridges efficiently, by regulating the passage amount of the electron beam at the pseudo-bridge so as to be similar to that of the normal bridge, with both means according to the second and third embodiments.

The Shield of the Incident Beam at the Pseudo-Bridge (X-Axis)

As mentioned above, in order to obtain an effect similar to that of the normal slot for the pseudo-bridge formed in the slot, it is desirable that the quantity of the electron beam passed through the lacuna of the pseudo-bridge is suppressed as much as possible. However, at the openings in the outer peripheral side in the Y-axis direction of the shadow mask, the arrangement which is called “deviation” may be adaptable in order that the electron beam from the mask center can pass through the mask without being subjected to shielding.

Then, when providing such deviation in the X-axis direction to a lacuna 3 in this way, a problem is arisen that the quantity of the electron beam which passes through a lacuna part of the pseudo-bridge can not be sufficiently suppressed.

Here, the deviation in the X-axis direction is described using FIG. 14. FIG. 14(a) shows the slot which has two openings 6 and the pseudo-bridge 4 which is formed between the openings 6 and it is a plan view which is seen from the screen side, i.e., from the side opposite to the electron gun side. Further, (b) shows the A-A′ arrow sectional view of (a).

With respect to this invention, the deviation in the Y-axis direction means the condition that, in the relation between the lengths in the X-axis direction on the surface of the side opposite to the electron gun side, the distance a of from the mask X-axial outer peripheral side edge m of the etching part on the mask surface to the mask X-axial outer peripheral side edge n of the opening (or the lacuna at the pseudo-bridge) is formed longer than the distance å of from the mask center side edge j of the etching part on the mask surface to the mask center side edge k of the opening (or the lacuna at the pseudo-bridge).

When such a deviation is formed, the electron beam 7 which comes to the lacuna 3 from the mask center, as shown in FIG. 14(b) , passes through the lacuna just as it is without being completely sheltered. With respect to the pseudo-bridge, its effect can be produced until when the quantity of the electron beam which passes through it is sufficiently suppressed, as described above. In this case, therefore, the need for suppression of the width of lacuna 3 is arisen. In general, however, it is often difficult because of the aspect of the etching precision.

Concretely, when giving full scope to the function of the pseudo-bridge, the passage quantity of the electron beam as the width of lacuna 3 is about 40 μm is desired, but the width of lacuna 3 is generally formed in the range of 50-80 μm in view of the etching precision. Therefore, a special means to reduce the passage amount of the electron beam is needed.

The fourth embodiment of this invention has been contrived under such aspect, and its characteristic is to specify the shape of the pseudo-bridge provided for the slot of the above shadow mask.

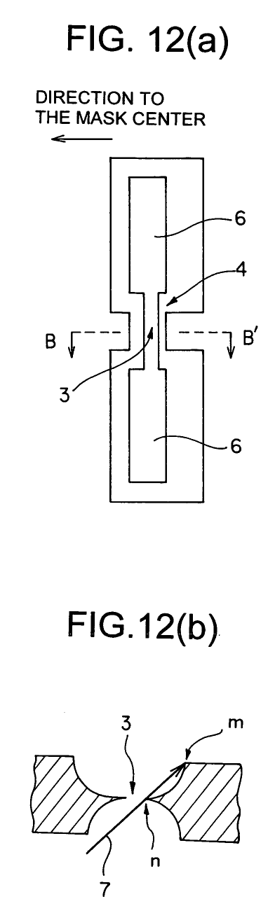

Now, the shape of the pseudo-bridge according to this invention is described using the drawings. FIG. 12(a) is the plan view which shows the slot part of the shadow mask of this invention when viewing from the screen side, i.e., from the side opposite to the electron gun side, and (b) is the B-B′ arrow sectional view thereof. As the example in these figures, the example that the pseudo-bridge 4 is formed between two openings 6 is illustrated. At each opening 6, the arrangement which is called deviation as illustrated in FIG. 14 is provided so that the electron beam from the mask center passes through the pseudo-bridge without being shielded.

The characteristic of this invention is to make the shape of the pseudo-bridge 4 formed between the openings 6 a shape satisfying the following relationship:

ä<t2×tan ã

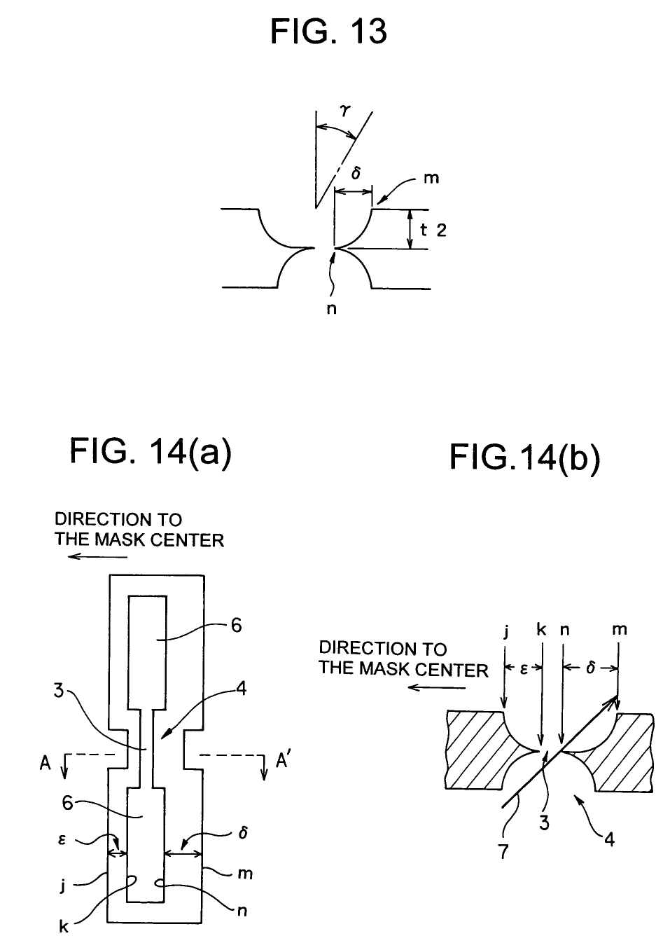

In this expression, ä is, as shown in FIG. 13, the distance in the X-axis direction of from the X-axial outer peripheral side edge m, i.e., the edge in the direction opposite to the mask center side, of the etching part 9 on the steel plate surface at the screen side to the X-axial outer peripheral side edge n, i.e., the edge in the direction opposite to the mask center side, of the lacuna in the pseudo-bridge. And t2 is, as shown in FIG. 13, the thickness of from the above mentioned edge n to the screen side surface of the steel plate, namely, the distance in the direction of Z-axis. Further, ã is the incidence angle of the electron beam to the pseudo-bridge 4, wherein the incidence angle ã is the angle with the Z-axis when the electron beam project its locus on the plane including the X-axis and Z-axis.

When the pseudo-bridge is formed so as to satisfy the above relationship, as shown in FIG. 12(b), at least the electron beam 7 irradiated along the edge n comes to be shielded by parts around the edge m of the etching part of the steel plate surface. Therefore, the quantity of the electron beam which passes pseudo-bridge 4 can be decreased by the quantity of the electron beam which is sheltered at around the edge m of the etching part on the steel plate surface. Therefore, the pseudo-bridge can produce the shade at a similar level with the normal bridge on the panel, and which can prevent the visual obstacle.

It is preferable that the above-mentioned relationship according to this invention is applied to areas where a is not less than 10°, particularly areas where a is not less than 20°, namely, areas of the outer peripheral side in the X-axis direction of the mask. This is because, at the areas where ã is less than the above mentioned range, namely, at the areas of center side in the X-axis direction, the value of ä calculated may be too small to satisfy the relationship in view of working difficulties.

With respect to the thickness of the steel sheet which is used for the shadow mask of this invention for the cathode-ray tube, a thickness within the range of generally used in this art may be adaptable. Concretely, a thickness in the range of 50 μm to 150 μm may be used. The above mentioned t2 generally has a thickness which is about a half of the thickness of the steel sheet.

The Widen-in-the-Middle Lacuna of the Pseudo-Bridge

In a case where the pseudo-bridges are provided for the slots as mentioned above, to form the pseudo-bridge 4 in the shape as shown in FIG. 4 will causes a possibility that the following problem occurs.

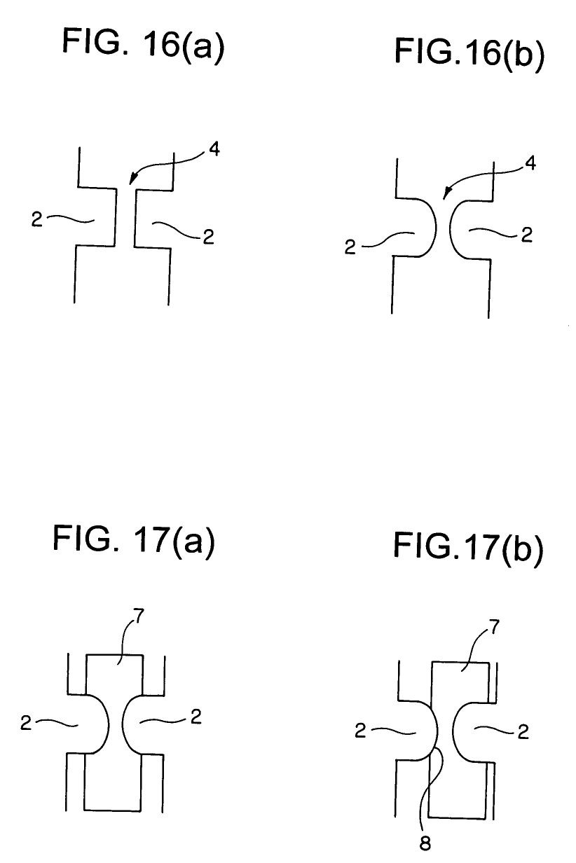

That is, when protuberances 2, 2 of the pseudo-bridge 4 have rectangular shapes as shown in FIG. 16(a), the shape of shadows on the panel as a cathode-ray tube becomes one having roundness at the edges of protuberances 2 of pseudo-bridge 4 as shown in FIG. 16(b) owing to the wraparound of the light, etc. In the case that the edges of protuberances 2 on the panel have such roundness, as far as the electron beam 7 is irradiated exactly as shown in FIG. 17(a), no problem will be happened. However, once the electron beam 7 is irradiated with a shift (misregistration) and the boundary part of the beam lies on the round part 8 in the edge of protuberance 2 as shown in FIG. 17(b) , a problem that the brightness is varied in proportion to the shifted amount is happened.

The fifth embodiment of this invention is characterized by the fact that the shape of such a lacuna in the pseudo-bridge provided at a slot of the shadow mask is formed as a shape where the width of at the middle part is wider than that at end part so as to form the shadow of the protuberance projected on the panel rectangularly, wherein the shape of lacuna is that viewing from the screen side or the electron gun side.

The Y-axial length of this pseudo-bridge is made similar with the length of an ordinary normal bridge. Although it depends on the size, the use, or the like of the cathode-ray tube, it is generally in the range of 60 im -150 im.

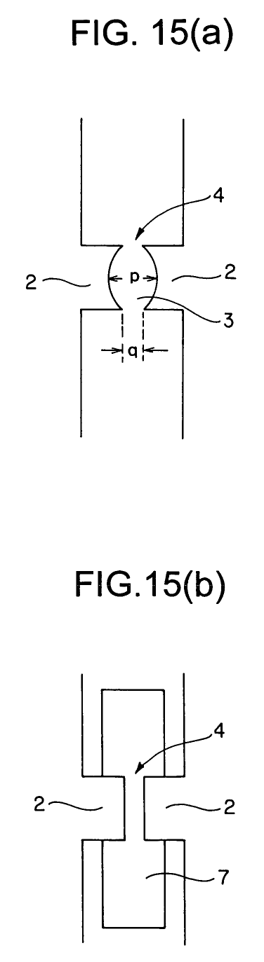

FIG. 15(a) shows the pseudo-bridge part of an example of the shadow mask according to the fifth embodiment of this invention. In this invention, the width p of the center is thick and the width q of the end part is attenuate, in the plane shape of lacuna 3 between two protuberances 2, 2 of the pseudo-bridge 4, i.e. , the shape viewing from the electron gun side, or from the opposite side, namely, the screen side.

In this invention, when the width p of the center of the lacuna is taken as 100%, the width q of the end part of the lacuna is preferable to be in the range of 50%-90%, and more preferably in the range of 70%-90%. Although the width q of the end part would be varied by the usage of the shadow mask, such as for television, for monitor, etc., and by the size of the shadow mask, it is generally formed to be in the range of 20 μm-70 μm.

As shown in FIG. 15(b) , when the lacuna has such a shape, the protuberances 2,2 in the pseudo-bridge 4 can form rectangular appearances on the panel. Thus, even when the electron beam shifts to some degree, it can not give a great influence to the brightness.

In this invention, the position for measuring the width p of the center does not have to be always the Y-axial center of the lacuna 3, and it is measured at a position where the width becomes the largest one and which is in the neighborhood of the center of lacuna 3. In other words, the shape of lacuna 3 is not particularly limited to what has the widest part at the Y-axial center, as far as it can make finally the protuberances on the panel approach rectangle.

Similarly, the position for measuring the width q of the end part does not have to be always at the both edge parts of lacuna 3 and it is measured at a position where the width becomes the narrowest one and which is in the neighborhood of the both edges of lacuna 3. Namely, the shape of lacuna 3 is not particularly limited to what has the narrowest parts at both edges, as far as it has the narrowest parts in the neighborhood of the both edges.

Further, with respect to the curves in the outline of the lacuna from the both ends to the center of the lacuna, they are not specifically limited to arcs, as far as they can make the lacuna side's edge lines of protuberances on the panel approach straight lines.

When such lacunae are formed by etching in the process of manufacturing the shadow mask, it is desirable to use a photomask of diamond or elliptical shape. In this case, the position where the width p of the center is measured, namely, the position which shows the widest width in the lacuna, is the position where opposite vertices lie in the diamond shape of the photo mask.

With respect to the thickness of the steel sheet which is used for the shadow mask of this invention for the cathode-ray tube, a thickness within the range of generally used in this art may be adaptable. Concretely, a thickness in the range of 80 μm to 150 μm may be used.

Incidentally, this fifth embodiment can be utilized in combination with any of the above mentioned other embodiments, and particularly, in combination with the first embodiment, it can bring a preferable result. Incidentally, as shown in FIG. 2 (b) , even when one of the end parts of the lacuna is narrower than the other end part of the lacuna, the effects similar to those of the aforementioned fifth embodiment can be expected as far as the width at the center of the lacuna is larger than at least the narrower end part of the lacuna.

In addition to the above mentioned combinations, it is possible to utilize the embodiments of this invention in the form of any combination therebetween, and the combination may be a combination of any two embodiments, of any three embodiments, of any four embodiments, or of all embodiments.

Incidentally, this invention is not limited to the above mentioned embodiments. The above mentioned embodiments are adapted only for the purpose of illustrating this invention. Any of which have substantially the same construction as the technical thought described in the claims has, and which can provide the same functions and effects are included in the technical range of this invention.

### EXAMPLES

Now, the shadow mask according to this invention for the cathode-ray tube is described concretely by the examples.

### Example 1

### The Deviation in the Y-Axis Direction in the Pseudo-Bridge

In the shadow mask for the 29-inches cathode-ray tube, the deviations in the Y-axis direction were formed at the location where the incident angle á of the electron beam in the Y-axis direction was 35° so that the width (A) of the inner etching part 9 was set as 71 im, and the width (B) of the outer etching part as 20 im (See FIG. 7.). Similarly, at the locations where the incident angle á was 15°, 25°, or 30°, the deviations in the Y-axis direction were formed. The width (A) of the inner etching part and the width (B) of the outer etching part in such locations are enumerated in the following Table 1. Incidentally, the thickness of the steel sheet in this case was 100 im.

TABLE 1

| The Y-axial | The width A | The width B |
|---|---|---|
| incident angle á | of the inside | of the outside |
| of the electron | etching | etching |
| beam (°) | part (ìm) | part (ìm) |
| 15 | 30 | 25 |
| 25 | 50 | 20 |
| 30 | 60 | 20 |
| 35 | 71 | 20 |

The cathode-ray tube which used this shadow mask was one with the good quality which did not show the degradation of the color purity by the diffused reflection of the electron beam.

### Example 2

### The Surfacial Shape in the Lacuna of the Pseudo-Bridge at the Electron Gun Side

When the lacunae 3 with a width of about 50 im were planned at the location where the incident angle á of the electron beam in the Y-axis direction was 35°, cutting planes having few of prominences could be formed by setting the width e at the outer peripheral side edge on the steel plate surface in the electron gun side as 100 im, and the mask center side edge f as 80 im, and thus being slanted between them.

### Example 3

Shielding of the Incident Beam at the Pseudo-Bridge (Y-Axis 1)

By using a steel plate of 100 im in thickness, a shadow mask for the 29-inches cathode-ray tube were manufactured. At a pseudo-bridge which was formed at the location where the incident angle á of the electron beam in the Y-axis direction was 35°, t and â of the above mentioned relationship were determined. As a result, it was found that t1=60 im, and â=40 im.

These measurements satisfied the relationship:

â<t1×tan á.

Similarly, at a pseudo-bridge which was formed at the location where the incident angle á of the electron beam in the Y-axis direction was 30°, it was found that t and a of the above mentioned relationship were t1=60 im , and â=30 im as a result of measuring; and at the location where the incident angle á was 25°, it was found that t1=60 im, and â=26 im. These measurements also satisfied the above mentioned relationship.

Since the cathode-ray tube which used such a shadow mask satisfied the above relationship, the electron beam irradiated was shielded by the protuberances of pseudo-bridge, and thus, the visual obstacle where the normal bridges were emphasized and the horizontal black strips were observed could not observed at this cathode-ray tube.

### Example 4

### Shielding of the Incident Beam at the Pseudo-Bridge (Y-axis 2)

A shadow mask which had normal bridges and pseudo-bridges the widths in the Y-axis direction of which are shown in FIG. 2 was manufactured.

TABLE 2

| | Width D1 of the | Width D2 of the | The value of |
|---|---|---|---|
| | regular bridge | pseudo-brid ge | (D2 − D1) |
| | in the Y-axis | in the Y-axis | when D1 is |
| Position | direction (ìm) | direction (ìm) | 100% (%) |
| Y-axial | 50 | 120 | 140 |
| center | | | |
| 100 mm | 90 | 133 | 48 |
| position | | | |
| from | | | |
| Y-axial | | | |
| center | | | |
| 170 mm | 115 | 140 | 21 |
| position | | | |
| from | | | |
| Y-axial | | | |
| center | | | |

Since, in the cathode-ray tube which used the shadow mask thus manufactured, the passage amount of the electron beam at the pseudo-bridge was similar to that of the normal bridge, the visual obstacle where the normal bridges were emphasized and the horizontal black strips were observed could not observed at this cathode-ray tube.

### Example 5

### Shielding of the Incident Beam at the Pseudo-Bridge (X-axis)

A tension type shadow mask was manufactured by forming slots which had pseudo-bridge in a steel plate by etching. The steel plate used was 130 im in thickness, and the mask was formed so that the value a shown in FIG. 13 was gradually increased as the position was off from the center to outside in the X-axial direction.

The values t2 and ä determined at the X-axial center, at 100 mm position from X-axial center in the X-axis direction, and at 210 mm position from X-axial center in the X-axis direction are enumerated in Table 3, together with the values ã and the values t2×tan ã.

TABLE 3

| Position | ã (°) | t2 (mm) | ä (mm) | t2 × tan ã |
|---|---|---|---|---|
| X-axial center | 0 | 70 | 40 | 0 |
| 100 mm position | 25 | 64 | 25 | 30 |
| from X-axial center | | | | |
| 210 mm position | 40 | 60 | 22 | 50 |
| from X-axial center | | | | |

As clear from table 3, the shadow mask of this example was what met ä<t2×tan ã at the positions which left the X-axial center by equal to or more than 100 mm in the X-axis direction.

When installing this shadow mask in the cathode-ray tube, the problem such as the visual obstacle was not observed.

### Example 6

### Shadow Mask for TV

A shadow mask which had the pseudo-bridge of the shape as shown in FIG. 15(a) was manufactured. In order to form the lacuna of the pseudo-bridge, a photomask of the diamond shape was used. The width q at the end part of the lacuna was determined as 45 im and the width p at the center was determined as 60 im. In this case, the width q at the end part was 75% of the width p at the center.

At the cathode-ray tube for the TV which used such a shadow mask, protuberances of the pseudo-bridge observed on the panel were rectangular.

### Example 7

### Shadow Mask for Monitor

A shadow mask which had the pseudo-bridge of the shape as shown in FIG. 15(a) was manufactured. In order to form the lacuna of the pseudo-bridge, a photomask of the diamond shape was used, same as Example 6. The width q at the end part of the lacuna was determined as 20 im and the width p at the center was determined as 30 im. In this case, the width q at the end part was 67% of the width p at the center.

At the cathode-ray tube for monitor which used such a shadow mask, protuberances of the pseudo-bridge observed on the panel were rectangular.

### Industrial Utility

As mentioned above, in this invention, since the pseudo-bridges are provided with the deviation in the Y-axis direction, even at the outer peripheral side in the Y-axis direction of the shadow mask, the side being where the incidence angle of the electron beam becomes larger, the diffused reflection will not occur when the electron beam irradiates to the protuberance of the pseudo-bridge. Therefore, problems such as image turbulence which is caused by the diffused reflection of the electron beam can be prevented.

Further, in this invention, since the protuberances of the pseudo-bridge has a shape satisfying the relationship, ã<t1×tan á, the electron beam passing through the protuberance of the pseudo-bridge is obstructed around the outer peripheral edge of the inside etching part in the Y-axis direction. Thus, it is possible to decrease the quantity of electron beam passed through the pseudo-bridge, and the visual obstacle where the normal bridges are emphasized and the horizontal black strips are observed can be sufficiently prevented.

Further more, in this invention, since the pseudo-bridge is made the shape which satisfies the relationship, ä<t2×tan ã, the electron beam passing through the lacuna of the pseudo-bridge is obstructed at the edge of the side opposite to the mask center in the etching part on the mask surface. Thus, it is possible to decrease the quantity of electron beam passed through the lacuna of the pseudo-bridge, and a shadow which has a similar level with that of the regular bridge can be can be reflected onto the panel. The problem that the position of the regular bridge is taken by the naked eye as the line on the screen as a visual obstacle can be prevented.

Still further, in this invention, since the shape of the lacuna is prepared so that the width of the lacuna at the middle part of the lacuna is wider than that at end part of the lacuna, the shadow of the protuberance of the pseudo-bridge can be an almost rectangular appearance on the panel, and thus, the possibility of the brightness change on the somewhat shifting of electron beam can be expelled considerably.

1. Slot tension-type shadow mask for the cathode-ray tube,
wherein slots in the mask are provided individually with a pseudo-bridge which consists of protuberances and a lacuna between them, wherein the protuberances protrude toward the center of the slot in the direction of X-axis of the mask from either side of the slot along the Y-axis direction of the mask; and
in at least a part of the slots, each protuberance of the pseudo-bridge is provided with a deviation in the Y-axis direction, wherein the deviation in the Y-axis direction means a condition that, in the relation between the width of the etching part at the mask outer peripheral edge part side (outside etching part) in the Y-axis direction and the width of the etching part at the mask center part side (inside etching part) in Y-axis direction on the surface facing to a screen (being opposite in direction to an electron gun) , the inside etching part is longer than the outside etching part, the outside etching part being a part between an endmost point of the protuberance at the mask outer peripheral side in the Y-axis direction and a surface edge point of the protuberance at the outer peripheral side in the Y-axis direction on the surface facing to the screen, whereas the inside etching part being a part between another endmost point of the protuberance at the mask center side in the Y-axis direction and another surface edge point of the protuberance at the mask center side in the Y-axis direction on the surface facing to the screen.

2. Shadow mask for the cathode-ray tube according to claim 1, wherein the width of the lacuna of the pseudo-bridge at the outer peripheral side edge on the surface facing to the electron gun becomes wider than that at the mask center side edge, at a rate of 10% -100% .

3. Slot tension-type shadow mask for the cathode-ray tube,
wherein the slots in the mask are provided individually with a pseudo-bridge which consists of protuberances and a lacuna between them, wherein the protuberances protrude toward the center of the slot in the direction of X-axis of the mask from either side of the slot along the Y-axis direction of the mask; and
the inside etching part of the protuberance at the mask center side in the Y-axis direction and facing to the screen has a shape satisfying the relationship:
â<t1×tan á
wherein â is the distance of from the outer peripheral side edge of the inside etching part in the Y-axis direction to the mask center side edge of the protuberance, t1 is the thickness of from the mask center side edge of the protuberance to the surface facing to the screen, and á is the incidence angle of the electron beam to the pseudo-bridge, wherein the incidence angle á is the angle with the Z-axis when the electron beam project its locus on the plane including the Y-axis and Z-axis.

4. Slot tension-type shadow mask for the cathode-ray tube,
wherein the slots in the mask are provided individually with a pseudo-bridge which consists of protuberances and a lacuna between them, wherein the protuberances protrude toward the center of the slot in the direction of X-axis of the mask from either side of the slot along the Y-axis direction of the mask; and
the width of the pseudo-bridge in the Y-axis direction is wider than the width of the normal bridge in the Y-axis direction at a rate of 20%-150%.

5. Shadow mask for the cathode-ray tube according to claim 3,
wherein the width of the pseudo-bridge in the Y-axis direction is wider than the width of the normal bridge in the Y-axis direction at a rate of 20%-150%.

6. Slot tension-type shadow mask for the cathode-ray tube,
wherein the slots in the mask are provided individually with a pseudo-bridge which consists of protuberances and a lacuna between them, wherein the protuberances protrude toward the center of the slot in the direction of X-axis of the mask from either side of the slot along the Y-axis direction of the mask; and
the pseudo-bridge formed in each slot has a distance ä satisfying the relationship:
ä<t2×tan ã
wherein ä is the distance in the X-axis direction between the outer peripheral side edge of the etching part on the surface facing to the screen in the X-axis direction of the mask and the peripheral side edge of the lacuna of the pseudo-bridge in the X-axis direction, t2 is the thickness between the outer peripheral side edge of the lacuna of the protuberance and the mask surface facing to the screen, and ã is the incidence angle of the electron beam to the pseudo-bridge, wherein the incidence angle ã is the angle with the Z-axis when the electron beam project its locus on the plane including the X-axis and Z-axis.

7. Shadow mask for the cathode-ray tube according to claim 6, wherein the ä which satisfies the above relationship is formed in pseudo-bridges located at positions where the ã is not less than 10°.

8. Slot tension-type shadow mask for the cathode-ray tube,
wherein the slots in the mask are provided individually with a pseudo-bridge which consists of protuberances and a lacuna between them, wherein the protuberances protrude toward the center of the slot in the direction of X-axis of the mask from either side of the slot along the Y-axis direction of the mask; and
the lacuna has a shape where the width of the lacuna at the middle part of the lacuna is wider than that at end part of the lacuna.

9. Shadow mask for the cathode-ray tube according to claim 8, wherein the width of the lacuna at the end part is a 50%-90% width at the middle part.

10. Shadow mask for the cathode-ray tube according to claim 8 or 9, wherein the lacunae are formed using a photomask of diamond or elliptical shape.

11. Shadow mask for the cathode-ray tube according to claim 1, the lacuna has a shape where the width of the lacuna at the middle part of the lacuna is wider than that at the end of the lacuna.
